(19) United States
(12) Patent Application Publication
(10) Pub. No.: US 2007/0011440 A1
(43) Pub. Date: Jan. 11, 2007

(54) Processor and processing method

(75) Inventor: Junichi Niitsuma, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/358,207

(22) Filed: Feb. 22, 2006

(30) Foreign Application Priority Data
Jul. 7, 2005 (JP) 2005-198562

(51) Int. Cl. G06F 9/30

(52) U.S. Cl. 712/217

(57) ABSTRACT

A processor for performing processing based on an instruction code stored in an instruction memory. In the instruction code, a plurality of operations corresponding to a common calculation pattern are represented by a common instruction set designating logical registers. A register-assignment control unit includes a plurality of register-map tables, and determines one or more physical registers assigned to the logical registers designated by the common instruction set, by use of one of the register-map tables which is designated when the common instruction set is called, where each of the register-map tables stores information indicating assignment of one or more physical registers to logical registers.

### CROSS-REFERENCE TO RELATED APPLICATIONS

This application is based upon and claims the benefits of priority from the prior Japanese Patent Application No. 2005-198562, filed on Jul. 7, 2005, the entire contents of which are incorporated herein by reference.

### BACKGROUND OF THE INVENTION

1) Field of the Invention

The present invention relates to a processor and a processing method. In particular, the present invention relates to a processor which is to be built in a device of a type in which power saving is required (for example, mobile equipment), and a processing method executed in such a processor.

2) Description of the Related Art

In the current built-in type processors which are built in the devices of the type in which power saving is required (such as mobile equipment), the size of an instruction memory storing an instruction code is limited, and a technique for storing a complex program in such a small instruction memory is important. Therefore, there are demands for generation of an efficient instruction code, and efficient loading and execution of an instruction code which cannot be entirely stored in an instruction memory, and is supplied from a secondary memory, a hard disk, a network, or the like to the instruction memory.

For example, the following instruction code is used in conventional processors.

FIG. 6 is a diagram illustrating an example of a conventional instruction code. The instruction code 50 indicated in FIG. 6 includes instructions for calculating (a+b)×(a−b), and is stored in an instruction memory in a conventional processor.

As illustrated in FIG. 6, physical registers r1, r2, r3, and r4 for temporarily storing data during processing are directly designated in the instruction code 50. For example, the first line of the instruction set 50a instructs to add the values in the physical registers r0 and r1 together and write the sum of the values in the physical register r2, the second line of the instruction set 50a instructs to subtract the value in the physical register r1 from the value in the physical register r0 and write the difference in the physical register r0, and the third line of the instruction set 50a instructs to multiply the values in the physical registers r2 and r0 together and write the sum in the physical register r1.

In the conventional processor, the physical registers are assigned according to a program to be executed, and an instruction code as the instruction code 50 illustrated in FIG. 6 is generated for processing. For example, Japanese Unexamined Patent Publications Nos. 2002-175181 and 10-11352 disclose efficient assignment of registers.

However, in the instruction codes stored in the instruction memories in the conventional processors as in the instruction sets 50a, 50b, and 50c indicated in FIG. 6, even when operations corresponding to an identical calculation pattern are performed, the physical registers used in the respective operations are differentiated by register assignment performed by the compiler. That is, the number of instructions constituting each instruction code increases, and the increase in the number of instructions impedes downsizing of the instruction memory which stores the instruction code.

### SUMMARY OF THE INVENTION

The present invention is made in view of the above problems, and the first object of the present invention is to provide a processor which can reduce the number of instructions constituting an instruction code. In addition, the second object of the present invention is to provide a processing method which can reduce the number of instructions constituting an instruction code.

In order to accomplish the first object, a processor for performing processing based on an instruction code stored in an instruction memory is provided. The processor comprises: the instruction memory storing the instruction code, in which a plurality of operations corresponding to a common calculation pattern are represented by a common instruction set designating logical registers; and a register-assignment control unit which includes a plurality of register-map tables, and determines one or more physical registers assigned to the logical registers designated by the common instruction set, by use of one of the register-map tables which is designated when the common instruction set is called, where each of the register-map tables stores information indicating assignment of one or more physical registers to logical registers.

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

FIG. 1 is a diagram illustrating the construction of a processor according to the first embodiment of the present invention.

FIG. 2 is a diagram illustrating an example of an instruction code used in the processor according to the first embodiment of the present invention.

FIG. 3 is a diagram illustrating register-map tables.

FIG. 4 is a diagram illustrating the construction of a processor according to the second embodiment of the present invention.

FIG. 5 is a flow diagram indicating an outline of processing for generating an instruction code.

FIG. 6 is a diagram illustrating an example of a conventional instruction code.

### DESCRIPTION OF THE PREFERRED EMBODIMENTS

Preferred embodiments of the present invention will be explained below with reference to the accompanying drawings, wherein like reference numbers refer to like elements throughout.

### First Embodiment

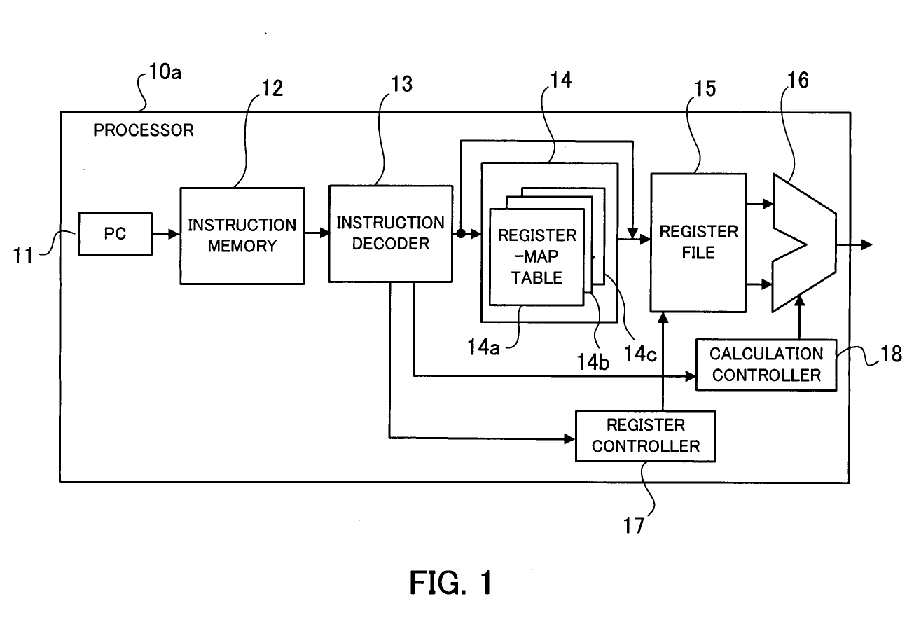

FIG. 1 is a diagram illustrating the construction of a processor according to the first embodiment of the present invention. The processor 10a according to the first embodiment comprises a program counter (PC) 11, an instruction memory 12, an instruction decoder 13, a register management unit 14, a register file 15, an arithmetic-and-logical unit (ALU) 16, a register controller 17, and a calculation controller 18.

The program counter 11 stores an address in the instruction memory 12 of an instruction which is to be executed next, and the address stored in the program counter 11 is updated with the address of the next instruction every time an instruction is executed.

The instruction memory 12 stores an instruction code executed by the processor 10a. The instruction code may be originally written in an assembly language. Alternatively, it is possible to use as the instruction code a code which is obtained by a compiler compiling a program written in a high-level language such as the C language. The instruction code may be loaded from a secondary memory, a hard disk, a network, or the like into the instruction memory 12.

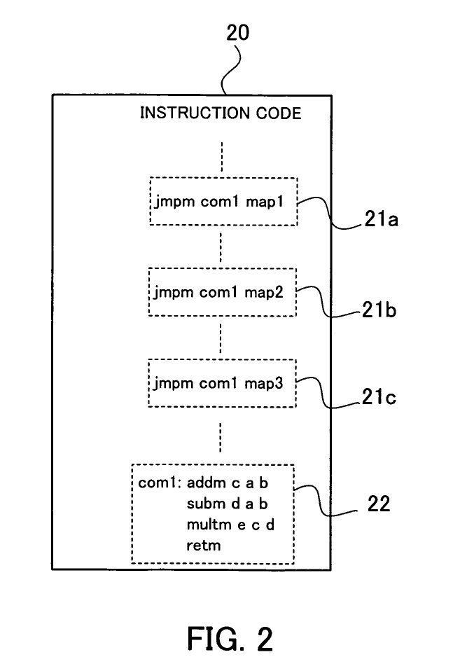

FIG. 2 is a diagram illustrating an example of the instruction code used in the processor according to the first embodiment of the present invention. The example of the instruction code indicated in FIG. 2 is written in an assembly language.

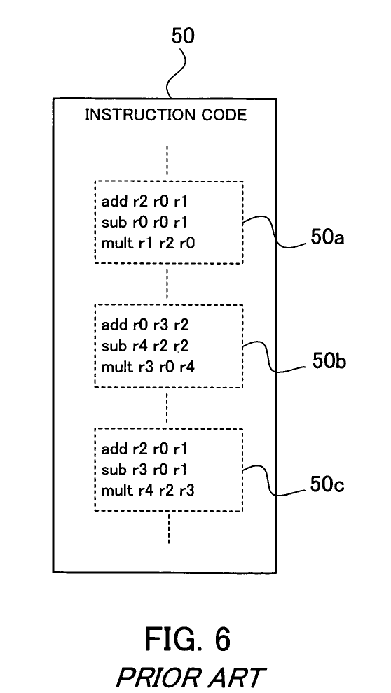

When a program to be executed contains instruction sets 21a, 21b, and 21c which instruct to perform operations corresponding to a common calculation pattern (represented by an identical algorithm, for example, (a+b)×(a−b)), the instruction code 20 used in the processor 10a calls a common instruction set 22 which describes the operations corresponding to the above common calculation pattern by designating ones of the logical registers a, b, c, d, and e, instead of directly designating the physical registers as in the conventional processor (indicated in FIG. 6). When the common instruction set 22 is called in each of the instruction sets 21a, 21b, and 21c, the instruction set designates one of the register-map tables 14a, 14b, and 14c (explained later) in order to determine one or more physical registers assigned to ones of the logical registers a, b, c, d, and e which are designated by the common instruction set 22. In the example of FIG. 2, in order to indicate that the instructions use the register-map tables 14a, 14b, and 14c, the operation codes (opcodes) “jmpm,” “addm,” “subm,” “multm,” and “retm” of the call instruction for the common instruction set 22, the add instruction, the subtract instruction, the multiply instruction, and the return instruction are ended with the character “m.”

Referring back to FIG. 1, the instruction decoder 13 decodes each instruction set to be executed, and informs the register management unit 14 of one or more logical registers and one of the register-map tables 14a, 14b, and 14c which are designated by the instruction set. In addition, the instruction decoder 13 informs the register file 15 of the address of one or more physical registers designated by each normal instruction which does not call the common instruction set 22. Further, the instruction decoder 13 informs the register controller 17 of a write instruction, a read instruction, or the like, and informs the calculation controller 18 of a calculation instruction such as an add instruction, a subtract instruction, or the like.

The register management unit 14 stores the plurality of register-map tables 14a, 14b, and 14c.

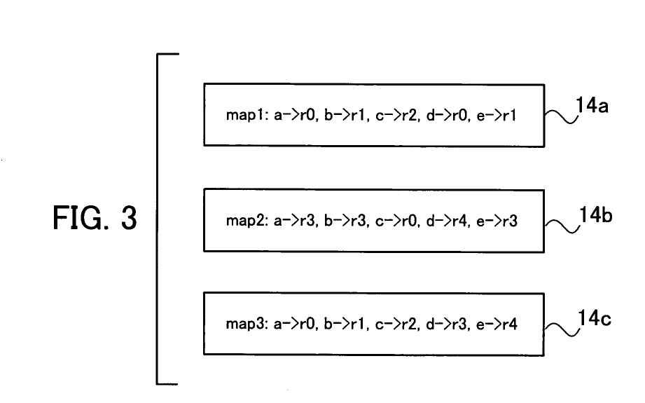

FIG. 3 is a diagram illustrating register-map tables.

As indicated in FIG. 3, each of the register-map tables 14a, 14b, and 14c holds information indicating ones of the physical registers r0, r1, r2, r3, and r4 which are assigned to the logical registers a, b, c, d, and e designated by the common instruction set 22. The register management unit 14 stores the plurality of register-map tables 14a, 14b, and 14c. In each of the register-map tables 14a, 14b, and 14c, ones of the physical registers r0, r1, r2, r3, and r4 are differently assigned to the logical registers a, b, c, d, and e. The data held by the register management unit 14 are written in the register-map tables 14a, 14b, and 14c before execution of the program.

When the common instruction set 22 as indicated in FIG. 2 is called in each of the instruction sets 21a, 21b, and 21c during execution of the program, the register management unit 14 switches the selection to one of the register-map tables 14a, 14b, and 14c designated by the instruction set, so that it is possible to change the assignment of the physical registers r0, r1, r2, r3, and r4 to the logical registers a, b, c, d, and e. Then, the register management unit 14 determines ones of the physical registers r0, r1, r2, r3, and r4 which are to be used, by outputting to the register file 15 the addresses of the ones of the physical registers r0, r1, r2, r3, and r4 which are assigned to the logical registers a, b, c, d, and e.

The register file 15 is constituted by a plurality of physical registers in which data are temporarily stored during processing. As mentioned before, one or more physical registers used in the processing can be selected by the designated addresses outputted from the instruction decoder 13 or the register management unit 14.

The arithmetic-and-logical unit 16 performs processing such as arithmetic processing or logical processing on the basis of values stored in the physical registers.

The register controller 17 controls operations of writing and reading data into and from the physical registers selected according to the result of the decoding by the instruction decoder 13.

The calculation controller 18 reads data from the physical registers selected from the register file 15 according to the result of the decoding by the instruction decoder 13, and controls the processing (such as addition or subtraction) performed by the arithmetic-and-logical unit 16.

For simple illustration, data written in the selected physical registers and a data memory for storing results of processing are not shown In FIG. 1.

Next, the operations of the processor 10a according to the first embodiment are explained below for an exemplary case where the instruction code 20 indicated in FIG. 2 and the register-map tables 14a, 14b, and 14c-indicated in FIG. 3 are used.

When the program counter 11 selects the instruction set 21a in the instruction code 20 in the instruction memory 12, the call instruction “jmpm com1” calls the common instruction set 22 “com1.” At this time, the register management unit 14 assigns the physical registers r0, r1, r2, r0, and r1 to the logical registers a, b, c, d, and e, respectively, by using the register-map table “map1” 14a designated by the instruction set 21a.

In the first line of the common instruction set 22, the instruction “addm c a b” is executed. At this time, the values in the logical registers a and b are added together, and the sum of the values is stored in the logical register c. Since the register-map table “map1” 14a is selected when the common instruction set 22 is called, the register management unit 14 outputs the addresses of the physical registers r0, r1, and r2 respectively corresponding to the logical registers a, b, and c which are designated by the instruction “addm c a b.”

Thus, the physical registers r0, r1, and r2 in the register file 15 are selected, and the arithmetic-and-logical unit 16 actually performs the calculation in accordance with the instruction “add r2 r0 r1” under control of the register controller 17 and the calculation controller 18.

In the second line of the common instruction set 22, the instruction “subm d a b” is executed. At this time, the value in the logical register b is subtracted from the value in the logical register a, and the value obtained by the subtraction is stored in the logical register d. Since the register-map table “map1” 14a is selected, the register management unit 14 outputs the addresses of the physical register r0, r1, and r0 respectively corresponding to the logical registers a, b, and d which are designated by the instruction “subm d a b.”

Thus, the physical registers r0 and r1 in the register file 15 are selected, and the arithmetic-and-logical unit 16 actually performs the calculation in accordance with the instruction “sub r0 r0 r1” under control of the register controller 17 and the calculation controller 18.

In the third line of the common instruction set 22, the instruction “multm e c d” is executed. At this time, the values in the logical registers c and d are multiplied together, and the product of the values is stored in the logical register e. Since the register-map table “map1” 14a is selected, the register management unit 14 outputs the addresses of the physical registers r2, r0, and r1 respectively corresponding to the logical registers c, d, and e which are designated by the instruction “multm e c d.”

Thus, the physical registers r0, r1, and r2 in the register file 15 are selected, and the arithmetic-and-logical unit 16 actually performs the calculation in accordance with the instruction “mult r1 r2 r0” under control of the register controller 17 and the calculation controller 18.

In the last line of the common instruction set 22, the return instruction “retm” is executed. This instruction instructs to return to the line next to the executed call instruction “jmpm.” Since the common instruction set 22 is called by the instruction set 21a, the return instruction “retm” returns the operation to the line next to the instruction set 21a.

Further, the instruction sets 21b and 21c are executed in similar manners to the instruction set 21a except that the register-map table “map2” 14b is designated when the common instruction set 22 is called by the instruction set 21b, and the register-map table “map3” 14c is designated when the common instruction set 22 is called by the instruction set 21c. Therefore, when the instruction set 21b is executed, the register management unit 14 switches the selection from the register-map table 14a designated by the instruction set 21a to the register-map table 14b designated by the instruction set 21b. Then, when the instruction set 21c is executed, the register management unit 14 switches the selection from the register-map table 14b designated by the instruction set 21b to the register-map table 14c designated by the instruction set 21c.

Thus, it is possible to perform similar calculations by changing assignment of physical registers r0, r1, r2, r3, and r4 to the logical registers a, b, c, d, and e.

As explained above, the processor 10a according to the first embodiment uses the instruction code 20 in which a plurality of operations corresponding to a common calculation pattern are represented by a common instruction set 22 designating of the logical registers a, b, c, d, and e, and determines ones of the physical registers r0, r1, r2, r3, and r4 assigned to the logical registers a, b, c, d, and e according to one of register-map tables 14a, 14b, and 14c which is designated when the common instruction set 22 is called. Therefore, it is possible to reduce the number of instructions constituting the instruction code, and reduce the size of the instruction memory 12 which stores the instruction code.

### Second Embodiment

Hereinbelow, a processor according to the second embodiment of the present invention is explained.

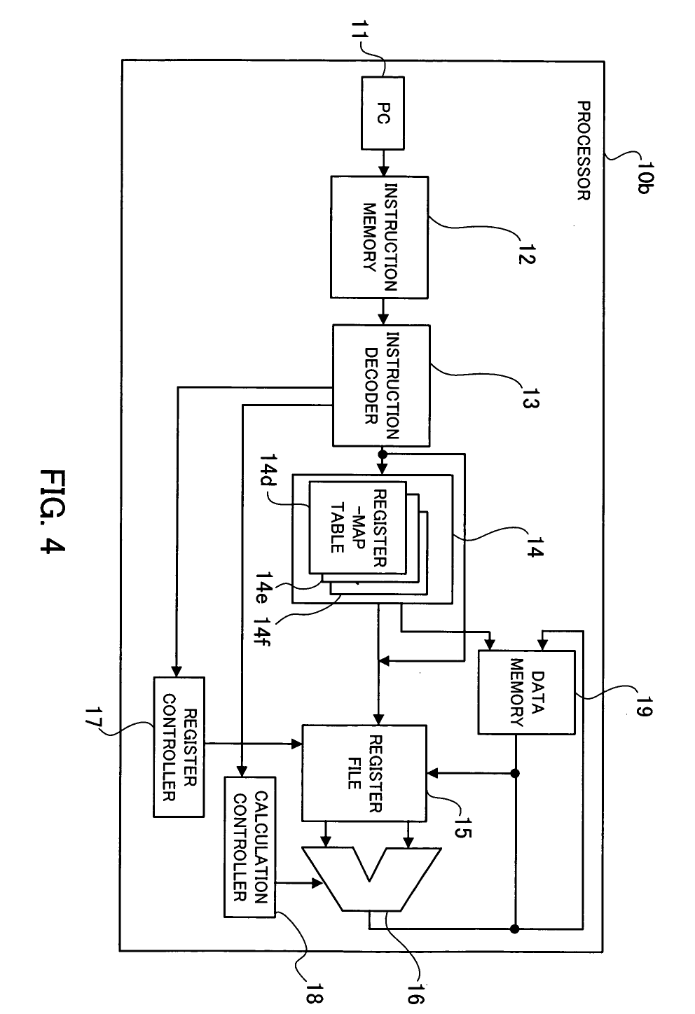

FIG. 4 is a diagram illustrating the construction of the processor according to the second embodiment of the present invention.

Normally, when a processor cannot perform a calculation by using only a limited number of physical registers (i.e., when register spilling occurs), the values to be stored in the physical registers are temporarily saved into a data memory 19. Although the data memory 19 is not shown in FIG. 1, the data memory 19 stores results of calculations performed by the arithmetic-and-logical unit 16, and data to be written in the physical registers in the register file 15. In some cases, portions of the calculation results may be stored in the register file 15, and a selector (not shown) can divide the calculation results between the data memory 19 and the calculation controller 18.

In the processor 10b according to the second embodiment, the register-map tables 14d, 14e, and 14f in the register management unit 14 manage addresses in the data memory 19 into which the values which are to be stored in the physical registers are temporarily saved when the one or more physical registers assigned to the logical registers as mentioned before are insufficient for performing a calculation. For example, an assignment of an address in the data memory 19 and the aforementioned physical register r0 to the aforementioned logical register a (in FIG. 2) may be defined as “a→r0→add1.” That is, even when register spilling occurs, addresses in the data memory 19 into which data are to be saved, as well as the physical registers, can be assigned to logical registers. Therefore, it is possible to provide a countermeasure against the register spilling without substantial increase in the size of the instruction code.

### Processing Sequence

The instruction code 20 used in the processor 10a or 10b according to the first or second embodiment of the present invention may be originally written with instruction sets in an assembly language as indicated in FIG. 2. However, in consideration of convenience of development, it is desirable that the processor 10a or 10b use a compiler and allow use of a high-level language such as the C language.

Hereinbelow, processing for generating an instruction code 20 as indicated in FIG. 2 by compiling a description in the C language.

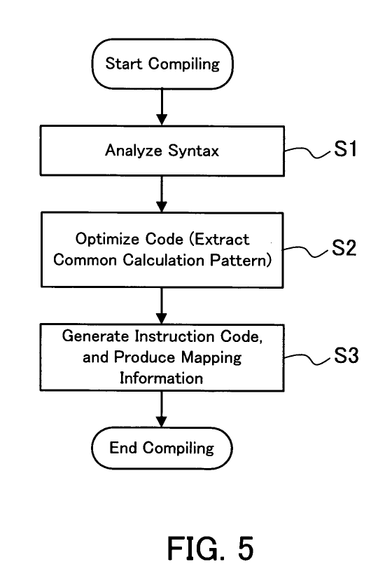

FIG. 5 is a flow diagram indicating an outline of processing for generating an instruction code.

When compiling is started, the syntax of a description in the C language including a for-statement, an if-statement, and the like is analyzed so as to generate an intermediate representation code (in step Si).

Next, architecture-dependent optimization or algorithmic optimization of the intermediate representation code is performed. At this time, operations in accordance with a common calculation pattern (represented by an identical algorithm) are extracted (in step S2).

After the optimization, a common instruction set which represents the above common calculation pattern by designating logical registers, for example, as indicated in FIG. 2, is generated. At this time, data of the register-map tables 14a, 14b, and 14c illustrated in FIG. 3 and the register-map tables 14d, 14e, and 14f provided for handling the register spilling are generated (in step S3).

### Advantages and Additional Matters

According to the present invention, an instruction code in which a plurality of operations corresponding to a common calculation pattern are represented by a common instruction set using of logical registers is used, and physical registers assigned to the logical registers are determined according to a register-map table which is designated when a common instruction set is called. Therefore, it is possible to reduce the number of instructions constituting the instruction code, and reduce the size of an instruction memory storing the instruction code.

In the processors 10a and 10b according to the first and second embodiments, the common instruction set is described in instructions designating logical registers. Therefore, it is unnecessary to consider assignment of physical registers during compiling, and the common calculation pattern can be extracted from the program by considering only the calculation procedures in the program.

Since a common calculation pattern is extracted from the program, and a common instruction set designating logical registers is generated, it is possible to reduce the number of instructions constituting an instruction code and the size of the instruction memory 12 storing the instruction code even in the case where the program is complex.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A processor for performing processing based on an instruction code stored in an instruction memory, comprising:
the instruction memory storing the instruction code, in which a plurality of operations corresponding to a common calculation pattern are represented by a common instruction set designating logical registers; and
a register-assignment control unit which includes a plurality of register-map tables, and determines one or more physical registers assigned to the logical registers designated by the common instruction set, by use of one of the register-map tables which is designated when the common instruction set is called, where each of the register-map tables stores information indicating assignment of one or more physical registers to logical registers.

2. The processor according to claim 1, wherein one of the register-map tables stores, as information indicating assignment to a logical register, an address of a memory into which a value to be stored in a physical register is temporarily saved when the one or more physical registers determined by the register-assignment control unit are insufficient for calculation.

3. The processor according to claim 1, wherein the instruction code is generated by compiling a program described in a high-level language so that the common calculation pattern is extracted from the program, and the common instruction set is produced on the basis of the common calculation pattern.

4. A processing method for performing processing based on an instruction code stored in an instruction memory, comprising the steps of:
(a) storing the instruction code in the instruction memory, where in the instruction code, a plurality of operations corresponding to a common calculation pattern are represented by a common instruction set designating logical registers;
(b) storing a plurality of register-map tables each of which stores information indicating assignment of one or more physical registers to logical registers; and
(c) determining one or more physical registers assigned to the logical registers designated by the common instruction set, by use of one of the register-map tables which is designated when the common instruction set is called.

5. The processing method according to claim 4, wherein one of the register-map tables stores, as information indicating assignment to a logical register, an address of a memory into which a value to be stored in a physical register is temporarily saved when the one or more physical registers determined by the register-assignment control unit are insufficient for calculation.

6. The processing method according to claim 4, wherein the instruction code is generated by compiling a program described in a high-level language so that the common calculation pattern is extracted from the program, and the common instruction set is produced on the basis of the common calculation pattern.
